(19) United States
(12) Patent Application Publication
(10) Pub. No.: US 2019/0358892 A1
(43) Pub. Date: Nov. 28, 2019

(54) OPTICAL SHAPING INK SET, OPTICALLY SHAPED ARTICLE, AND METHOD FOR PRODUCING OPTICALLY SHAPED ARTICLE

(71) Applicant: Maxell Holdings, Ltd., Kyoto (JP)

(72) Inventors: Katsuyuki KITO, Kyoto (JP); Taeko IZUMO, Kyoto (JP)

(21) Appl. No.: 16/476,760

(22) PCT Filed: Jan. 31, 2017
(86) PCT No.: PCT/JP2017/003471

§ 371 Date: Jul. 9, 2019

(51) Int. Cl. B29C 64/10; B29C 64/40

(52) U.S. Cl. CPC B29C 64/10; B29K 2023/12; B29K 2023/04; B29C 64/40

(57) ABSTRACT

An optical shaping ink set comprises a composition (I) for a model material and a composition (II) for a support material. Composition (I) comprises 50 to 74 PBW (parts by weight) of a monofunctional ethylenically unsaturated monomer (A), 26 to 50 PBW of a polyfunctional ethylenically unsaturated monomer (B), and 2 to 20 PBW of a photopolymerization initiator (C) per 100 PBW of the total composition for the model material, and (B) contains an alkoxylated polyfunctional ethylenically unsaturated monomer, but does not contain an ethylenically unsaturated monomer having a urethane group. Composition (II) comprises 20 to 50 PBW of a water-soluble monofunctional ethylenically unsaturated monomer (a), 20 to 49 PBW of a polyalkylene glycol (b) containing EO and/or PO, 35 PBW or less of a water-soluble organic solvent (c), and 5 to 20 PBW of a photopolymerization initiator (d) per 100 PBW of the total composition for the support material.

### TECHNICAL FIELD

The present invention relates to an optical shaping ink set (an ink set for stereolithography) used in inkjet optical shaping method (inkjet stereolithography), an optically shaped article (a stereolithographic article) shaped by using the optical shaping ink set and a method for producing an optically shaped article (a stereolithographic article) using the optical shaping ink set.

### BACKGROUND ART

Conventionally, as a method for making a stereoscopically shaped article, a shaping method using a photocurable composition that is cured by irradiating ultraviolet rays or the like has been widely known. Specifically, in such a shaping method, by irradiating a photocurable composition with ultraviolet rays or the like to cure it, a cured layer having a predetermined shape is formed. Thereafter, a new cured layer is formed by further feeding a photocurable composition on the cured layer to cure it. By repeatedly performing the step as described above, a stereoscopically shaped article is made.

Among the above-described shaping methods, in recent years, stereolithography by an inkjet system of discharging a photocurable composition from a nozzle, and irradiating ultraviolet rays or the like immediately after that to cure it, thereby, forming a cured layer having a predetermined shape (hereinafter, referred to as inkjet optical shaping method) has been reported (Patent Document 1). The inkjet optical shaping method does not need installation of a large resin liquid tank for storing a photocurable composition and a darkroom. For that reason, a shaping apparatus can be miniaturized as compared with the conventional method. Attention has been paid to the inkjet optical shaping method as a shaping method which is realized by a 3D printer that can freely make a stereoscopically shaped article, based on CAD (Computer Aided Design) data.

In the inkjet optical shaping method, when an optically shaped article having a complicated shape such as a hollow shape is shaped, in order to support a model material, the model material and a support material are formed in combination (Patent Document 1). The support material is made by irradiating a photocurable composition with ultraviolet rays or the like to cure it, like the model material. After the model material has been made, the support material can be removed by physically peeling the support material, or dissolving the support material in an organic solvent or water.

In the inkjet optical shaping method using the model material and the support material, the cured layer is formed, for example, by the following method. First, by discharging a composition for a model material and a composition for a support material from an inkjet head, a composition layer in which a layer made of the composition for the model material and a layer made of the composition for the support material are adjacent is formed. Then, in order to smooth an upper surface of the composition layer, the excess composition for the model material and the composition for the support material are removed using a roller. Finally, by irradiating these compositions with light using a light source, the compositions are cured. Thereby, a cured layer made of the model material and the support material is formed.

### PRIOR ART DOCUMENT

### Patent Document

Patent Document 1: JP-A-2012-111226

### SUMMARY OF THE INVENTION

### Problems to be Solved by the Invention

However, the conventional optically shaped article which is obtained by using a composition for a model material and a composition for a support material had a problem that the dimensional accuracy is reduced.

The present invention has been made in view of the above-mentioned present situation, and an object of the present invention is to provide an optical shaping ink set by which an optically shaped article having good dimensional accuracy can be obtained, an optically shaped article shaped by using the optical shaping ink set and a method for producing an optically shaped article using the optical shaping ink set.

### Solutions to the Problems

The present inventors have intensively studied the cause for reduction in the dimensional accuracy of the optically shaped article. As a result, the present inventors have obtained the finding that in an optically shaped article having reduced dimensional accuracy, by movement of one of a composition for a model material and a composition for a support material to the other side at an interface between a layer made of the composition for the model material and a layer made of the composition for the support material, blur (bleeding) is generated at the interface. That is, the present inventors have obtained the finding that bleeding which is generated at the interface between the layer made of the composition for the model material and the layer made of the composition for the support material is one of the causes for reduction in the dimensional accuracy of the optically shaped article.

Moreover, the present inventors have obtained the finding that the lack of self-supportability of the support material is one of the causes of reducing the dimensional accuracy of an optically shaped article. The present inventors have found that a support material having excellent self-supportability can be obtained by defining contents of an unpolymerized component and a water-soluble monofunctional ethylenically unsaturated monomer in the composition for the support material in a predetermined range.

The present invention has been made based on the above findings, and the gist of the present invention is as follows.

(1) An optical shaping ink set used for inkjet optical shaping method, comprising in combination:

a composition for a model material used for shaping a model material; and

a composition for a support material used for shaping a support material,

wherein the composition for the model material contains, per 100 parts by weight of the total composition for the model material:
50 to 74 parts by weight of a monofunctional ethylenically unsaturated monomer (A);
26 to 50 parts by weight of a polyfunctional ethylenically unsaturated monomer (B); and
2 to 20 parts by weight of a photopolymerization initiator (C); and

wherein the composition for the support material contains, per 100 parts by weight of the total composition for the support material:
20 to 50 parts by weight of a water-soluble monofunctional ethylenically unsaturated monomer (a);
20 to 49 parts by weight of a polyalkylene glycol (b) containing an oxyethylene group and/or an oxypropylene group;
35 parts by weight or less of a water-soluble organic solvent (c); and
5 to 20 parts by weight of a photopolymerization initiator (d).

(2) The optical shaping ink set according to the above item (1), wherein in the composition for the model material, the polyfunctional ethylenically unsaturated monomer (B) contains an alkoxylated polyfunctional ethylenically unsaturated monomer, but does not contain an ethylenically unsaturated monomer having a urethane group.

(3) The optical shaping ink set according to the above item (1) or (2), wherein in the composition for the model material, the monofunctional ethylenically unsaturated monomer (A) contains a water-insoluble monofunctional ethylenically unsaturated monomer.

(4) The optical shaping ink set according to any one of the above items (1) to (3), wherein in the composition for the model material, the photopolymerization initiator (C) is one or more selected from an acylphosphine oxide-based compound, an α-aminoalkylphenone-based compound, and an α-hydroxyketone-based compound.

(5) The optical shaping ink set according to any one of the above items (1) to (4), wherein in the composition for the support material, the content of the water-soluble monofunctional ethylenically unsaturated monomer (a) is 25 to 45 parts by weight per 100 parts by weight of the total composition for the support material.

(6) The optical shaping ink set according to any one of the above items (1) to (5), wherein in the composition for the support material, the content of the polyalkylene glycol (b) is 25 to 45 parts by weight per 100 parts by weight of the total composition for the support material.

(7) The optical shaping ink set according to any one of the above items (1) to (6), wherein in the composition for the support material, the content of the water-soluble organic solvent (c) is 5 parts by weight or more per 100 parts by weight of the total composition for the support material.

(8) The optical shaping ink set according to any one of the above items (1) to (7), wherein the composition for the support material further comprises 0.05 to 3.0 parts by weight of a storage stabilizer (e) per 100 parts by weight of the total composition for the support material.

(9) An optically shaped article shaped by inkjet optical shaping method using the optical shaping ink set according to any one of the above items (1) to (8).

(10) A method for producing an optically shaped article by inkjet optical shaping method using the optical shaping ink set according to any one of the above items (1) to (8), the method comprising:

step (I) of obtaining a model material by photocuring the composition for the model material and, and at the same time, obtaining a support material by photocuring the composition for the support material; and step (II) of removing the support material.

### Effects of the Invention

According to the present invention, it is possible to provide an optical shaping ink set by which an optically shaped article having good dimensional accuracy can be obtained, an optically shaped article shaped by using the optical shaping ink set and a method for producing an optically shaped article using the optical shaping ink set.

### BRIEF DESCRIPTION OF THE DRAWINGS

FIG. 1 is a view schematically showing step (I) in the method for producing the optically shaped article according to the present embodiment.

FIG. 2 is a view schematically showing step (II) in the method for producing the optically shaped article according to the present embodiment.

FIG. 3(a) is a top view of a cured product which is obtained by using each composition for a model material and each composition for a support material shown in Table 1. FIG. 3(b) is a cross-sectional view taken along line A-A of FIG. 3(a).

### EMBODIMENTS OF THE INVENTION

One embodiment of the present invention (hereinafter, also referred to as the present embodiment) is described in detail below. The present invention is not limited to the following contents. Meanwhile, in the following description, “(meth)acrylate” is a generic name of acrylate and methacrylate, and means one or both of acrylate and methacrylate. This also applies to “(meth)acryloyl” and “(meth)acryl”.

1. Composition for Model Material

<Monofunctional Ethylenically Unsaturated Monomer (A)>

The composition for the model material included in the optical shaping ink set according to the present embodiment contains a monofunctional ethylenically unsaturated monomer (A). The monofunctional ethylenically unsaturated monomer (A) is a polymerizable monomer having one ethylenic double bond in the molecule, which has a property of being cured with an energy ray. The monofunctional ethylenically unsaturated monomer (A) contains a water-insoluble monofunctional ethylenically unsaturated monomer (A1) and/or a water-soluble monofunctional ethylenically unsaturated monomer (A2).

Examples of the water-insoluble monofunctional ethylenically unsaturated monomer (A1) include a linear or branched alkyl (meth)acrylate having 1 to 30 carbon atoms [for example, methyl (meth)acrylate, ethyl (meth)acrylate, isobutyl (meth)acrylate, lauryl (meth)acrylate, stearyl (meth)acrylate, isostearyl (meth)acrylate, t-butyl (meth)acrylate and the like], an alicycle-containing (meth)acrylate having 6 to 20 carbon atoms [for example, cyclohexyl (meth)acrylate, cyclohexyl (meth)acrylate, 4-t-butylcyclohexyl acrylate, isobornyl (meth)acrylate, phenoxyethyl (meth)acrylate, dicyclopentanyl (meth)acrylate, adamantyl (meth)acrylate and the like], a heterocycle-containing (meth)acrylate having 5 to 20 carbon atoms [for example, tetrahydrofurfuryl (meth)acrylate, 4-(meth)acryloyloxymethyl-2-methyl-2-ethyl-1,3-dioxolane, 4-(meth)acryloyloxymethyl-2-cyclohexyl-1,3-dioxolane and the like] and the like. Each of them may be used alone, or two or more of them may be used in combination.

Among them, from the viewpoint of improving curability of the composition for the model material, one or more selected from isobornyl (meth)acrylate, phenoxyethyl (meth)acrylate, and tetrahydrofurfuryl (meth)acrylate are preferable. Furthermore, isobornyl (meth)acrylate is more preferable from the viewpoint of improving the dimensional accuracy of the model material since the composition for the model material has heat resistance that can withstand the temperature (50 to 90° C.) at the time of photocuring.

Examples of the water-soluble monofunctional ethylenically unsaturated monomer (A2) include a hydroxy group-containing (meth)acrylate having 5 to 15 carbon atoms [for example, hydroxyethyl (meth)acrylate, hydroxypropyl (meth)acrylate, 4-hydroxybutyl (meth)acrylate and the like], a hydroxy group-containing (meth)acrylate having an Mn of 200 to 1,000 [polyethylene glycol mono(meth)acrylate, polyalkoxy (1 to 4 carbon atoms) glycol mono(meth)acrylate, polypropylene glycol mono(meth)acrylate, mono(meth)acrylate of PEG-PPG block polymer and the like], a (meth)acrylamide derivative having 3 to 15 carbon atoms [(meth)acrylamide, N-methyl (meth)acrylamide, N-ethyl (meth)acrylamide, N-propyl (meth)acrylamide, N-butyl (meth)acrylamide, N,N′-dimethyl (meth)acrylamide, N,N′-diethyl (meth)acrylamide, N-hydroxyethyl (meth)acrylamide, N-hydroxypropyl (meth)acrylamide, N-hydroxybutyl (meth)acrylamide and the like], (meth)acryloylmorpholine and the like. Each of them may be used alone, or two or more of them may be used in combination. Among them, from the viewpoint of improving curability of the composition for the support material and the viewpoint of a low skin irritation to the human body, N-hydroxyethyl (meth)acrylamide or (meth)acryloylmorpholine is preferable.

The molecular weight of the monofunctional ethylenically unsaturated monomer (A) is preferably 200 or more, and preferably 2,000 or less.

The content of the monofunctional ethylenically unsaturated monomer (A) per 100 parts by weight of the total composition for the model material is 50 to 74 parts by weight from the viewpoint of improving curability of the composition for the model material. It is preferable that the content of the monofunctional ethylenically unsaturated monomer (A) is 55 parts by weight or more. In addition, it is preferable that the content of the monofunctional ethylenically unsaturated monomer (A) is 65 parts by weight or less. Meanwhile, when two or more of the components (A) are contained, the content is a total of the contents of respective components (A).

<Polyfunctional Ethylenically Unsaturated Monomer (B)>

The composition for the model material included in the optical shaping ink set according to the present embodiment contains a polyfunctional ethylenically unsaturated monomer (B). The polyfunctional ethylenically unsaturated monomer (B) is a polymerizable monomer having two or more ethylenic double bonds in the molecule, which has a property of being cured by an energy ray. The polyfunctional ethylenically unsaturated monomer (B) preferably contains an alkoxylated polyfunctional ethylenically unsaturated monomer, but preferably does not contain an ethylenically unsaturated monomer having a urethane group. When the polyfunctional ethylenically unsaturated monomer (B) contains an alkoxylated polyfunctional ethylenically unsaturated monomer but does not contain an ethylenically unsaturated monomer having a urethane group, the polarity of the composition for the model material is lowered, and as a result, it is possible to suppress the occurrence of bleeding at the interface between the layer made of the composition for the model material and the layer made of the composition for the support material described later.

Examples of the polyfunctional ethylenically unsaturated monomer (B) include a linear or branched alkylene glycol di(meth)acrylate having 2 to 20 carbon atoms [for example, tripropylene glycol di(meth)acrylate, 1,6-hexanediol di(meth)acrylate, neopentyl glycol di(meth)acrylate, 1,9-nonanediol di(meth)acrylate, 3-methyl-1,5-pentanediol di(meth)acrylate, 2-n-butyl-2-ethyl-1,3-propanediol di(meth)acrylate, pentaerythritol tri(meth)acrylate and the like], an alicycle-containing di(meth)acrylate having 10 to 30 carbon atoms [for example, dimethylol tricyclodecane di(meth)acrylate, tricyclodecane dimethanol di(meth)acrylate and the like] and the like. Each of them may be used alone, or two or more of them may be used in combination. Among them, from the viewpoint of improving curability of the composition for the model material, one or more selected from tripropylene glycol di(meth)acrylate, 1,6-hexanediol di(meth)acrylate, and tricyclodecane dimethanol di(meth)acrylate are preferable.

Among the polyfunctional ethylenically unsaturated monomer (B), examples of the alkoxylated polyfunctional ethylenically unsaturated monomer include a compound of which alcohol contained in an acrylate compound is ethoxylated or propoxylated and the like. Examples of the alcohol include trihydric, tetrahydric and hexahydric alcohols and the like. Specifically, examples include trimethylolpropane, pentaerythritol, glycerol, ditrimethylolpropane, dipentaerythritol and the like. The number of the ethoxylation or propoxylation is a multiple of 3 such as 3, 6, and 9 in the case of a trihydric alcohol, a multiple of 4 such as 4, 8, and 12 in the case of a tetrahydric alcohol and a multiple of 6 such as 6, 12, and 18 in the case of a hexahydric alcohol, but they are not particularly limited. Examples of the acrylate compound include trimethylolpropane triacrylate, pentaerythritol triacrylate, pentaerythritol tetraacrylate, glyceryl triacrylate, ditrimethylolpropane tetraacrylate, dipentaerythritol hexaacrylate and the like. Examples of the compound in which alcohol contained in the acrylate compound is ethoxylated or propoxylated include ethoxylated (3) trimethylolpropane triacrylate, ethoxylated (9) trimethylolpropane triacrylate, propoxy (3) trimethylolpropane triacrylate and the like. Each of them may be used alone, or two or more of them may be used in combination.

The molecular weight of the polyfunctional ethylenically unsaturated monomer (B) is preferably 200 or more, and preferably 2,000 or less.

The content of the polyfunctional ethylenically unsaturated monomer (B) per 100 parts by weight of the total composition for the model material is 26 to 50 parts by weight from the viewpoint of improving curability of the composition for the model material. It is preferable that the content of the polyfunctional ethylenically unsaturated monomer (B) is 30 parts by weight or more. In addition, it is preferable that the content of the polyfunctional ethylenically unsaturated monomer (B) is 45 parts by weight or less. Meanwhile, when two or more of the components (B) are contained, the content is a total of the contents of respective components (B).

<Photopolymerization Initiator (C)>

The composition for the model material included in the optical shaping ink set according to the present embodiment contains a photopolymerization initiator (C). The photopolymerization initiator (C) is not particularly limited, as far as it is a compound which promotes a radical reaction when light of a wavelength in an ultraviolet ray, near ultraviolet ray or visible light region is irradiated.

Examples of the photopolymerization initiator (C) include an acylphosphine oxide-based compound [for example, 2,4,6-trimethylbenzoyl-diphenyl-phosphine oxide, bis-(2,6-dimethoxybenzoyl)-2,4,4-trimethylpentylphosphine oxide, bis(2,4,6-trimethylbenzoyl)-phenylphosphine oxide and the like], an α-aminoalkylphenone-based compound [for example, 2-methyl-1[4-(methylthio)phenyl]-2-morpholinopropan-1-one, 2-benzyl-2-dimethylamino-1-(4-morpholinophenyl)butanone-1,2-methyl-1-[4-(methoxythio)-phenyl]-2-morpholinopropan-2-one and the like], an α-hydroxyketone-based compound [for example, 1-hydroxy-cyclohexyl-phenyl-ketone, 2-hydroxy-1-{4-[4-(2-hydroxy-2-methyl-propionyl)-benzyl]-phenyl}-2-methyl-propan-1-one, 2-hydroxy-4′-hydroxyethoxy-2-methylpropiophenone and the like], a benzoin-based compound [for example, benzoin, benzoinmethyl ether, benzoinethyl ether, benzoinpropyl ether, benzoinisobutyl ether and the like], an acetophenone-based compound [for example, acetophenone, 2,2-diethoxy-2-phenylacetophenone, 2,2-diethoxy-2-phenylacetophenone, 1,1-dichloroacetophenone, 2-hydroxy-2-methyl-phenylpropan-1-one, diethoxyacetophenone, 1-hydroxycyclohexyl phenyl ketone, 2-methyl-1-[4-(methylthio)phenyl]-2-morpholinopropan-1-one and the like], an anthraquinone-based compound [for example, 2-ethylanthraquinone, 2-t-butylanthraquinone, 2-chloroanthraquinone, 2-amylanthraquinone and the like], a thioxanthone-based compound [for example, 2,4-diethylthioxanthone, 2-isopropylthioxanthone, 2-chlorothioxanthone and the like], a ketal-based compound [for example, acetophenonedimethylketal, benzyldimethylketal and the like], a benzophenone-based compound [for example, benzophenone, 4-benzoyl-4′-methyldiphenylsulfide, 4,4′-bismethylaminobenzophenone and the like], a mixture of these compounds and the like. Each of them may be used alone, or two or more of them may be used in combination. Among them, from the viewpoint of improving light resistance of the model material obtained by photocuring the composition for the model material, an acylphosphine oxide-based compound, an α-aminoalkylphenone-based compound, or an α-hydroxyketone-based compound is preferable. In addition, examples of the photopolymerizable initiator which is available include DAROCURE TPO, IRGACURE 184, IRGACURE 907 manufactured by BASF SE and the like.

The content of the photopolymerization initiator (C) is 2 to 20 parts by weight per 100 parts by weight of the total composition for the model material from the viewpoint of improving photopolymerizability. The content of the photopolymerization initiator (C) is preferably 5 parts by weight or more, and preferably 18 parts by weight or less. Meanwhile, when two or more of the components (C) are contained, the content is a total of the contents of respective components (C).

<Other Additives>

The composition for the model material included in the optical shaping ink set according to the present embodiment may contain, if necessary, other additive(s) as long as effects of the present invention are not inhibited. Examples of the other additive(s) include a surface conditioner, a storage stabilizer, an antioxidant, a coloring agent, an ultraviolet absorber, a photostabilizer, a polymerization inhibitor, a chain transfer agent, a filler and the like.

The surface conditioner may be contained to adjust the surface tension of the composition for the model material to an appropriate range. By adjusting the surface tension of the composition for the model material to an appropriate range, mixing of the composition for the model material and the composition for the support material at the interface can be suppressed. As a result, by using these compositions, an optically shaped article with good dimensional accuracy can be obtained. In order to obtain the effect, it is preferable that the content of the surface conditioner is 0.005 to 3.0 parts by weight per 100 parts by weight of the total composition for the model material.

Examples of the surface conditioner include a silicone-based compound and the like. Examples of the silicone-based compound include a silicone-based compound having a structure of polydimethyl siloxane and the like. Specifically, examples of the silicone-based compound include polyether-modified polydimethyl siloxane, polyester-modified polydimethyl siloxane, polyaralkyl-modified polydimethyl siloxane and the like. Examples thereof which may be used include, in trade names, BYK-300, BYK-302, BYK-306, BYK-307, BYK-310, BYK-315, BYK-320, BYK-322, BYK-323, BYK-325, BYK-330, BYK-331, BYK-333, BYK-337, BYK-344, BYK-370, BYK-375, BYK-377, BYK-UV3500, BYK-UV3510, BYK-UV3570 (all manufactured by BYK Japan KIK), TEGO-Rad2100, TEGO-Rad2200N, TEGO-Rad2250, TEGO-Rad2300, TEGO-Rad2500, TEGO-Rad2600, TEGO-Rad2700 (all manufactured by Degussa AG), GLANOL 100, GLANOL 115, GLANOL 400, GLANOL 410, GLANOL 435, GLANOL 440, GLANOL 450, B-1484, Polyflow ATF-2, KL-600, UCR-L72, UCR-L93 (all manufactured by KYOEISHA CHEMICAL Co., LTD.) and the like. Each of them may be used alone, or two or more of them may be used in combination. In the case where two or more surface conditioners are contained, the content is a total of the contents of respective surface conditioners.

The storage stabilizer may be contained in order to enhance preservation stability of the composition for the model material. Additionally, the storage stabilizer can prevent head clogging generated by polymerization of a polymerizable compound with the heat energy. In order to obtain these effects, it is preferable that the content of the storage stabilizer is 0.05 to 3.0 parts by weight per 100 parts by weight of the total composition for the model material.

Examples of the storage stabilizer include a hindered amine-based compound (HALS), a phenol-based antioxidant, a phosphorus-based antioxidant and the like. Specifically, examples thereof include hydroquinone, methoquinone, benzoquinone, p-methoxyphenol, hydroquinone monomethyl ether, hydroquinone monobutyl ether, TEMPO, 4-hydroxy-TEMPO, TEMPOL, cupferron A1, IRGASTAB UV-10, IRGASTAB UV-22, FIRSTCURE ST-1 (manufactured by Albemarle Corporation), t-butylcatechol, pyrogallol, TINUVIN 111 FDL, TINUVIN 144, TINUVIN 292, TINUVIN XP40, TINUVIN XP60, TINUVIN 400 manufactured by BASF SE and the like. Each of them may be used alone, or two or more of them may be used in combination. Meanwhile, when two or more of the storage stabilizers are contained, the content is a total of the contents of respective storage stabilizers.

A method for producing the composition for the model material included in the optical shaping ink set according to the present embodiment is not particularly limited. The composition for the model material can be manufactured, for example, by uniformly mixing the components (A) to (C), and if necessary, the above-described other additive(s) using a mixing and stirring device or the like.

The thus manufactured composition for the model material preferably has a viscosity of 70 mPa·s or less at 25° C. from the viewpoint of improvement of dischargeability from an inkjet head. Meanwhile, measurement of the viscosity of the composition for the model material is performed using an R100-type viscometer in accordance with JIS Z 8803.

2. Composition for Support Material

<Water-Soluble Monofunctional Ethylenically Unsaturated Monomer (a)>

The composition for the support material included in the optical shaping ink set according to the present embodiment contains a water-soluble monofunctional ethylenically unsaturated monomer (a). The water-soluble monofunctional ethylenically unsaturated monomer (a) is a component that is polymerized by light irradiation to cure the composition for the support material. Moreover, the water-soluble monofunctional ethylenically unsaturated monomer (a) is a component which dissolves the support material obtained by photocuring the composition for the support material in water quickly.

The water-soluble monofunctional ethylenically unsaturated monomer (a) is a water-soluble polymerizable monomer having one ethylenic double bond in a molecule, which has property of being cured by energy rays. Examples of the component (a) include a hydroxy group-containing (meth)acrylate having 5 to 15 carbon atoms [for example, hydroxyethyl (meth)acrylate, hydroxypropyl (meth)acrylate, 4-hydroxybutyl (meth)acrylate and the like], an alkylene oxide adduct-containing (meth)acrylate having an Mn of 200 to 1,000 [polyethylene glycol mono(meth)acrylate, monoalkoxy (1 to 4 carbon atoms) polyethylene glycol mono(meth)acrylate, polypropylene glycol mono(meth)acrylate, monoalkoxy (1 to 4 carbon atoms) polypropylene glycol mono(meth)acrylate, mono(meth)acrylate of PEA-PPA block polymer and the like], a (meth)acrylamide derivative having 3 to 15 carbon atoms [(meth)acrylamide, N-methyl (meth)acrylamide, N-ethyl (meth)acrylamide, N-propyl (meth)acrylamide, N-butyl (meth)acrylamide, N,N′-dimethyl (meth)acrylamide, N,N′-diethyl (meth)acrylamide, N-hydroxyethyl (meth)acrylamide, N-hydroxypropyl (meth)acrylamide, N-hydroxybutyl (meth)acrylamide and the like], (meth)acryloylmorpholine and the like. Each of them may be used alone, or two or more of them may be used in combination.

Among them, from the viewpoint of improving curability of the composition for the support material, N,N′-dimethyl (meth)acrylamide, N-hydroxyethyl (meth)acrylamide, (meth)acryloylmorpholine and the like are preferable. Further, from the viewpoint of a low skin irritation to the human body, N-hydroxyethyl (meth)acrylamide, and (meth)acryloylmorpholine are more preferable.

The content of the water-soluble monofunctional ethylenically unsaturated monomer (a) is 20 to 50 parts by weight per 100 parts by weight of the total composition for the support material. When the content of the water-soluble monofunctional ethylenically unsaturated monomer (a) is less than 20 parts by weight, the self-supportability of the support material is not sufficient. Therefore, when the support material is disposed in the lower layer of the model material, the model material cannot be sufficiently supported. As a result, the dimensional accuracy of the model material is degraded. On the other hand, when the content of the water-soluble monofunctional ethylenically unsaturated monomer (a) exceeds 50 parts by weight, the support material has poor solubility in water. When the immersion time in water until the support material is completely removed is long, the model material slightly expands. As a result, the dimensional accuracy may be deteriorated in the microstructure portion of the model material. The content of the water-soluble monofunctional ethylenically unsaturated monomer (a) is preferably 25 parts by weight or more, and preferably 45 parts by weight or less. Meanwhile, when two or more of the components (a) are contained, the content is a total of the contents of respective components (a).

<Polyalkylene Glycol (b) Containing Oxyethylene Group and/or Oxypropylene Group>

The composition for the support material included in the optical shaping ink set according to the present embodiment contains a polyalkylene glycol (b) containing an oxyethylene group and/or an oxypropylene group. The polyalkylene glycol (b) can enhance the solubility of the support material in water.

The polyalkylene glycol (b) is obtained by adding at least ethylene oxide and/or propylene oxide to an active hydrogen compound. Examples of the polyalkylene glycol (b) include polyethylene glycol, polypropylene glycol and the like. Each of them may be used alone, or two or more of them may be used in combination. Examples of the active hydrogen compound include a monohydric to tetrahydric alcohol, an amine compound and the like. Among them, a dihydric alcohol or water is preferable.

The number average molecular weight Mn of the polyalkylene glycol (b) is preferably 100 to 5,000. When the Mn of the polyalkylene glycol (b) is within the above range, it is compatible with the water-soluble monofunctional ethylenically unsaturated monomer (a) before photocuring, and is incompatible with the water-soluble monofunctional ethylenically unsaturated monomer (a) after photocuring. As a result, self-supportability of the support material can be enhanced, and the solubility of the support material in water can be enhanced. The Mn of the polyalkylene glycol (b) is more preferably 200 to 3,000, and still more preferably 400 to 2,000.

The content of the polyalkylene glycol (b) is 20 to 49 parts by weight per 100 parts by weight of the total composition for the support material. When the content of the polyalkylene glycol (b) is less than 20 parts by weight, the support material has poor solubility in water. When the immersion time in water until the support material is completely removed is long, the model material slightly expands. As a result, the dimensional accuracy may be deteriorated in the microstructure portion of the model material. On the other hand, when the content of the polyalkylene glycol (b) exceeds 49 parts by weight, effusion of the polyalkylene glycol (b) may occur when the composition for the support material is photocured. When the effusion of the polyalkylene glycol (b) occurs, the adhesion at the interface between the support material and the model material is deteriorated. As a result, when the model material is cured and shrunk, it may be easily peeled off from the support material, and the dimensional accuracy may be deteriorated. In addition, when the content of the polyalkylene glycol (b) exceeds 49 parts by weight, the viscosity of the composition for the support material is increased. Accordingly, when the composition for the support material is discharged from the inkjet head, the jetting property may be deteriorated to cause flight deflection. As a result, the dimensional accuracy of the support material is degraded. Accordingly, the dimensional accuracy of the model material formed on the upper layer of the support material is also deteriorated. The content of the polyalkylene glycol (b) is preferably 25 parts by weight or more, and preferably 45 parts by weight or less. Meanwhile, when two or more of the components (b) are contained, the content is a total of the contents of respective components (b).

<Water-Soluble Organic Solvent (c)>

The composition for the support material included in the optical shaping ink set according to the present embodiment contains a water-soluble organic solvent (c). The water-soluble organic solvent (c) is a component that improves the solubility of the support material in water. In addition, the water-soluble organic solvent (c) is a component which adjusts the viscosity of the composition for the support material to be low.

Examples of the water-soluble organic solvent (c) include ethylene glycol monoacetate, propylene glycol monoacetate, diethylene glycol monoacetate, dipropylene glycol monoacetate, triethylene glycol monoacetate, tripropylene glycol monoacetate, tetraethylene glycol monoacetate, tetrapropylene glycol monoacetate, ethylene glycol monomethyl ether, propylene glycol monomethyl ether, triethylene glycol monomethyl ether, ethylene glycol monoethyl ether, propylene glycol monoethyl ether, ethylene glycol monopropyl ether, propylene glycol monopropyl ether, ethylene glycol monobutyl ether, propylene glycol monobutyl ether, tetrapropylene glycol monobutyl ether, ethylene glycol diacetate, propylene glycol diacetate, ethylene glycol dimethyl ether, propylene glycol dimethyl ether, ethylene glycol diethyl ether, propylene glycol diethyl ether, ethylene glycol dipropyl ether, propylene glycol dipropyl ether, ethylene glycol dibutyl ether, propylene glycol dibutyl ether, ethylene glycol monomethyl ether acetate, propylene glycol monomethyl ether acetate, dipropylene glycol monomethyl ether acetate, ethylene glycol monoethyl ether acetate, propylene glycol monoethyl ether acetate, ethylene glycol monopropyl ether acetate, propylene glycol monopropyl ether acetate, ethylene glycol monobutyl ether acetate, propylene glycol monobutyl ether acetate and the like. Each of them may be used alone, or two or more of them may be used in combination. Among them, triethylene glycol monomethyl ether, or dipropylene glycol monomethyl ether acetate is more preferable from the viewpoint of improving the solubility of the support material in water and adjusting the viscosity of the composition for the support material to be low.

The content of the water-soluble organic solvent (c) is 35 parts by weight or less per 100 parts by weight of the total composition for the support material. When the content of the water-soluble organic solvent (c) exceeds 35 parts by weight, during photocuring of the composition for the support material, effusion of the water-soluble organic solvent (c) occurs. Accordingly, the dimensional accuracy of the model material formed on the upper layer of the support material is deteriorated. The content of the water-soluble organic solvent (c) is preferably 5 parts by weight or more and more preferably 10 parts by weight or more from the viewpoint of improving the solubility of the support material in water and adjusting the viscosity of the composition for the support material to be low. Further, the content of the water-soluble organic solvent (c) is preferably 30 parts by weight or less. Meanwhile, when two or more of the components (c) are contained, the content is a total of the contents of respective components (c).

<Photopolymerization Initiator (d)>

The composition for the support material included in the optical shaping ink set according to the present embodiment contains a photopolymerization initiator (d). As the photopolymerization initiator (d), the component similar to the photopolymerization initiator (C) contained in the composition for the model material can be used.

The content of the photopolymerization initiator (d) is preferably 5 to 20 parts by weight per 100 parts by weight of the total composition for the support material. When the content of the photopolymerization initiator (d) is in the above range, the self-supportability of the composition for the support material is improved. Accordingly, the dimensional accuracy of the model material formed on the upper layer of the support material is improved. The content of the photopolymerization initiator (d) is more preferably 7 parts by weight or more, and more preferably 18 parts by weight or less. Meanwhile, when two or more of the components (d) are contained, the content is a total of the contents of respective components (d).

<Surface Conditioner (e)>

It is preferable that the composition for the support material included in the optical shaping ink set according to the present embodiment contains a surface conditioner (e) in order to adjust the surface tension of the composition for the support material to an appropriate range. By adjusting the surface tension of the composition for the support material to an appropriate range, mixing of the composition for the model material and the composition for the support material at the interface can be suppressed. As a result, by using the composition for the support material, an optically shaped article with good dimensional accuracy can be obtained. In order to obtain the effect, the content of the surface conditioner (e) is preferably 0.005 to 3.0 parts by weight per 100 parts by weight of the total composition for the support material.

As the surface conditioner (e), the component similar to the surface conditioner that may be contained in the composition for the model material can be used.

<Storage Stabilizer (f)>

It is preferable that the composition for the support material included in the optical shaping ink set according to the present embodiment further contains a storage stabilizer (f). The storage stabilizer (f) can enhance the preservation stability of the composition for the support material. Additionally, the storage stabilizer (f) can prevent head clogging generated by polymerization of a polymerizable compound with the heat energy. In order to obtain these effects, it is preferable that the content of the storage stabilizer (f) is 0.05 to 3.0 parts by weight per 100 parts by weight of the total composition for the support material.

As the storage stabilizer (f), the component similar to the storage stabilizer that may be contained in the composition for the model material can be used.

The composition for the support material included in the optical shaping ink set according to the present embodiment may contain, if necessary, other additive(s) as long as effects of the present invention are not inhibited. Examples of the other additive(s) include an antioxidant, a coloring agent, an ultraviolet absorber, a photostabilizer, a polymerization inhibitor, a chain transfer agent, a filler and the like.

A method for producing the composition for the support material included in the optical shaping ink set according to the present embodiment is not particularly limited. The composition for the support material can be manufactured, for example, by uniformly mixing the components (a) to (d), and if necessary, the components (e), (f) and other additive(s) using a mixing and stirring device or the like.

The thus manufactured composition for the support material preferably has a viscosity of 70 mPa s or less at 25° C. from the viewpoint of improvement of dischargeability from an inkjet head. Meanwhile, measurement of the viscosity of the composition for the support material is performed using an R100-type viscometer in accordance with JIS Z 8803.

3. Optically Shaped Article and Production Method Thereof

The optically shaped article according to the present embodiment is shaped by using the optical shaping ink set according to the present embodiment. Specifically, the optically shaped article is produced via step (I) of photocuring the above-described composition for the model material to obtain a model material, and at the same time, photocuring the above-described composition for the support material to obtain a support material, by inkjet optical shaping method, and step (II) of removing the support material. The step (I) and the step (II) are not particularly limited, but are performed, for example, by the following methods.

<Step (I)>

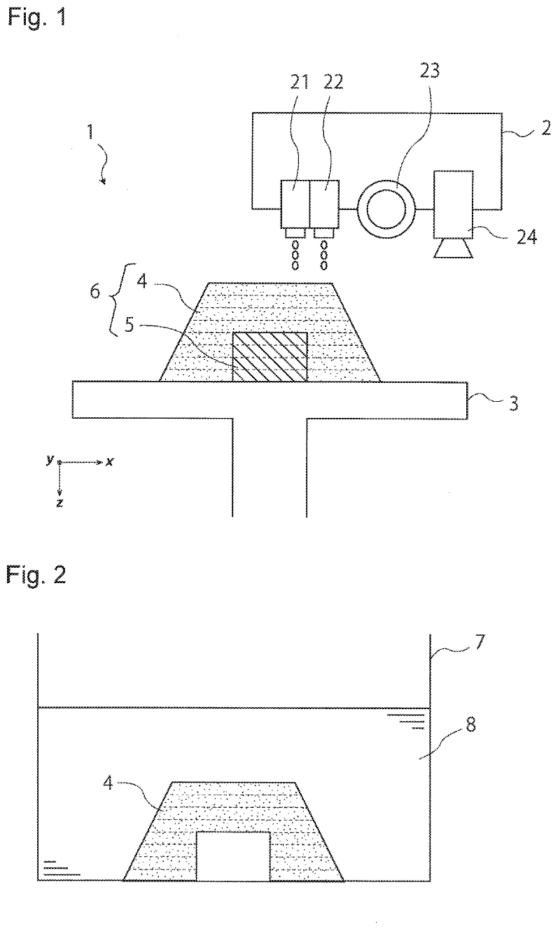

FIG. 1 is a view schematically showing the step (I) in the method for producing the optically shaped article according to the present embodiment. As shown in FIG. 1, a three-dimensional shaping apparatus 1 comprises an inkjet head module 2 and a shaping table 3. The inkjet head module 2 has an inkjet head for a model material 21 filled with a composition for a model material, an inkjet head for a support material 22 filled with a composition for a support material, a roller 23, and a light source 24.

First, the inkjet head module 2 is made to perform scanning in an X direction and a Y direction to the shaping table 3 in FIG. 1, and at the same time, the composition for the model material is discharged from the inkjet head for the model material 21, and the composition for the support material is discharged from the inkjet head for the support material 22, and thereby, a composition layer comprising the composition for the model material and the composition for the support material is formed. Then, in order to smooth an upper surface of the composition layer, the excess composition for the model material and the composition for the support material are removed using the roller 23. Then, these compositions are irradiated with light using the light source 24, and thereby, a cured layer comprising a model material 4 and a support material 5 is formed on the shaping table 3.

Next, the shaping table 3 is lowered in a Z direction in FIG. 1 by a thickness of the cured layer. Thereafter, by the same method as that described above, a cured layer comprising the model material 4 and the support material 5 is further formed on the cured layer. By performing these steps repeatedly, a cured product 6 comprising the model material 4 and the support material 5 is made.

Examples of the light which cures the composition include far infrared rays, infrared rays, the visible light, near ultraviolet rays, ultraviolet rays and the like. Among them, from the viewpoints of easiness and efficiency of curing operation, the light is preferably a near ultraviolet ray or an ultraviolet ray.

Examples of the light source 24 include a mercury lamp, a metal halide lamp, an ultraviolet LED, an ultraviolet laser and the like. Among them, from the viewpoint of miniaturization of facilities and electric power saving, the light source 24 is preferably an ultraviolet LED. Meanwhile, when the ultraviolet LED is used as the light source 24, the integrated light quantity of ultraviolet rays is preferably around 500 mJ/cm².

<Step (II)>

FIG. 2 is a view schematically showing the step (II) in the method for producing the optically shaped article according to the present embodiment. As shown in FIG. 2, the cured product 6 comprising the model material 4 and the support material 5, which has been made in the step (I), is immersed in a solvent 8 contained in a container 7. Thereby, the support material 5 can be removed by dissolving it in the solvent 8.

Examples of the solvent 8 which dissolves the support material include ion-exchanged water, distilled water, tap water, well water and the like. Among these, ion-exchanged water is preferable from the viewpoint of relatively low impurities and availability at low cost.

The optically shaped article according to the present embodiment can be obtained by the above steps. As described above, in the optical shaping ink set according to the present embodiment, the occurrence of bleeding at the interface between the layer made of the composition for the model material and the layer made of the composition for the support material can be suppressed. Moreover, in the optical shaping ink set according to the present embodiment, the support material excellent in self-supportability can be obtained by photocuring the composition for the support material included in the optical shaping ink set. The optically shaped article produced by using such the composition for the model material and the composition for the support material has good dimensional accuracy.

Examples which disclose the present embodiment more specifically are shown below. Meanwhile, the present invention is not limited only to these Examples.

### EXAMPLES

<Composition for Model Material>

(Production of Composition for Model Material)

In the formulation shown in Table 1, the components (A) to (C) and other additives were uniformly mixed by using a mixing and stirring device to produce the composition for the model material of each of Examples M1 to M11 and Comparative Example ml.

TABLE 1

| | | | | | | | | | | | | | | | Comparative |
|---|---|---|---|---|---|---|---|---|---|---|---|---|---|---|---|
| | | | | Examples | | | | | | | | | | | Example |
| Composition for model material | | | | M1 | M2 | M3 | M4 | M5 | M6 | M7 | M8 | M9 | M10 | M11 | m1 |
| Formulation | (A) | Monofunctional | ACMO | 30 | 30 | — | 30 | 30 | 30 | 30 | 25 | 34 | 25 | 25 | 30 |
| (parts by | | ethylenically | IBOA | 30 | — | 30 | 30 | 30 | 30 | 30 | 25 | 35 | 40 | 25 | 30 |
| weight) | | unsaturated | 4TBCHA | — | 30 | — | — | — | — | — | — | — | — | — | — |
| | | monomer | PEA | — | — | 30 | — | — | — | — | — | — | — | — | — |
| | (B) | Polyfunctional | HDDA | — | — | — | 5 | 5 | — | — | 5 | — | — | — | — |
| | | ethylenically | TPGDA | 5 | 5 | 5 | — | — | 5 | — | — | — | — | — | 5* |
| | | unsaturated | PE-3A | — | — | — | — | — | — | 5 | — | — | — | — | — |
| | | monomer | EO(3)TMPTA | — | — | — | 20 | — | — | — | — | — | — | — | — |
| | | | EO(9)TMPTA | 20 | 20 | 20 | — | — | 30 | 20 | 30 | 16 | 20 | 45 | — |
| | | | PO(3)TMPTA | | — | — | — | 20 | — | — | — | — | — | — | — |
| | | | EBECRYL600 | 10 | 10 | 10 | 10 | 10 | — | 10 | 10 | 10 | 10 | — | 10* |
| | (C) | Photopoly- | DAROCURE | 3 | 3 | 3 | 3 | 3 | 3 | 3 | 3 | 3 | 3 | 3 | 3 |
| | | merization | TPO | | | | | | | | | | | | |
| | | initiator | IRGACURE184 | 1.9 | 1.9 | 1.9 | 1.9 | 1.9 | 19 | 1.9 | 1.9 | 1.9 | 1.9 | 1.9 | 1.9 |

| | | | | | | | | | | | | | |
|---|---|---|---|---|---|---|---|---|---|---|---|---|---|
| Ethylenically | CN991 | — | — | — | — | — | — | — | — | — | — | — | 20 |
| unsaturated | | | | | | | | | | | | | |
| monomer containing | | | | | | | | | | | | | |
| urethane group | | | | | | | | | | | | | |
| Surface conditioner | TEGO-Rad2100 | 0.1 | 0.1 | 0.1 | 0.1 | 0.1 | 0.1 | 0.1 | 0.1 | 0.1 | 0.1 | 0.1 | 0.1 |

*means range out of that defined in claim 1.
ACMO: Acryloylmorpholine [ACMO (ethylenic double bond/one molecule: one), manufactured by KJ Chemicals Corporation]
IBOA: Isobornyl acrylate [Sartomer SR506D (ethylenic double bond/one molecule: one), manufactured by Arkema S.A.]
4TBCHA: 4-t-Butyl cyclohexyl acrylate [Sartomer SR217 (ethylenic double bond/one molecule: one), manufactured by Arkema S.A.]
PEA: Phenoxyethyl acrylate [Sartomer SR3339 (ethylenic double bond/one molecule: one), manufactured by Arkema S.A.]
HDDA: 1,6-Hexanediol diacrylate [Sartomer SR238 (ethylenic double bond/one molecule: two), manufactured by Arkema S.A.]
TPGDA: Tripropylene glycol diacrylate [Sartomer SR306 (ethylenic double bond/one molecule: two), manufactured by Arkema S.A.]
PE-3A: Pentaerythritol triacrylate oligomer [LIGHT ACRYLATE PE-3A (ethylenic double bond/one molecule: three), manufactured by KYOEISHA CHEMICAL Co., LTD.]
EO(3)TMPTA: Ethoxylated (3) trimethylolpropane triacrylate [Sartomer SR454 (ethylenic double bond/one molecule: three), manufactured by Arkema S.A.]
EO(9)TMPTA: Ethoxylated (9) trimethylolpropane triacrylate [Sartomer SR502 (ethylenic double bond/one molecule: three), manufactured by Arkema S.A.]
PO(3)TMPTA: Propoxylated (3) trimethylolpropane triacrylate [Sartomer SR492 (ethylenic double bond/one molecule: three), manufactured by Arkema S.A.]
EBECRYL600: Epoxy acrylate oligomer [EBECRYL600 (ethylenic double bond/one molecule: two), manufactured by Daicel-Cytec Co Ltd]
DAROCURE TPO: 2,4,6-Trimethylbenzoyl-diphenyl-phosphine oxide [DAROCURE TPO, manufactured by BASF SE]
IRGACURE184: 1-Hydroxy-cyclohexyl-phenyl-ketone [IRGACURE184, manufactured by BASF SE]
CN991: Urethane acrylate oligomer [CN991 (ethylenic double bond/one molecule: two), manufactured by Arkema S.A.]
TEGO-Rad2100: Silicone acrylate having a structure of polydimethyl siloxane [TEGO-Rad2100, manufactured by Evonik Degussa Japan Co., Ltd.]

<Composition for Support Material>

(Production of Composition for Support Material)

In the formulations shown in Tables 2 and 3, the components (a) to (f) were uniformly mixed by using a mixing and stirring device to produce the composition for the support material of each of Examples S1 to S17 and Comparative Examples s1 to s6. Using these compositions for the support materials, the following evaluation was performed.

Meanwhile, in the present Examples, as described later, the composition for the support material was cured by using an ultraviolet LED as an irradiation unit. With regard to the composition for the support material of Example S17, since the content of the photopolymerization initiator (d) exceeded 20 parts by weight, the photopolymerization initiator (d) was not sufficiently dissolved, and the undissolved matter was generated. Accordingly, even when the composition for the support material of Example S17 was irradiated with an ultraviolet LED, the composition was not satisfactory cured. Accordingly, the following evaluation was not performed at all with regard to the composition for the support material of Example S17. Meanwhile, when a mercury lamp or a metal halide lamp was used as an irradiation unit, the composition for the support material of Example S17 cured even if the content of the photopolymerization initiator (d) was 25 parts by weight.

TABLE 2

| | | | | Examples | | | | | | | | |
|---|---|---|---|---|---|---|---|---|---|---|---|---|
| Composition for support material | | | | S1 | S2 | S3 | S4 | S5 | S6 | S7 | S8 | S9 |
| Formulation | (a) | Water-soluble | HEAA | 25 | 25 | 25 | 25 | 25 | — | — | — | — |
| (parts by | | ethylenically | ACMO | — | — | — | — | — | 25 | — | 20 | 50 |
| weight) | | unsaturated | DMAA | — | — | — | — | — | — | 25 | — | — |
| | | monomer | | | | | | | | | | |
| | (b) | Polyalkylene | PPG-400 | 45 | — | — | — | — | — | — | — | — |
| | | glycol | PPG-1000 | — | 45 | — | — | 45 | 45 | 45 | 45 | 30 |
| | | containing | PEG-400 | — | — | 45 | — | — | — | — | — | — |
| | | oxyethylene | PEG-1000 | — | — | — | 45 | — | — | — | — | — |
| | | group and/or | | | | | | | | | | |
| | | oxypropylene | | | | | | | | | | |
| | | group | | | | | | | | | | |
| | (c) | Organic solvent | MTG | 21.6 | 21.6 | 21.6 | 21.6 | — | 21.6 | 21.6 | 26.6 | 11.6 |
| | | | DPMA | — | — | — | — | 21.6 | — | — | — | — |
| | (d) | Photopoly- | DAROCURE | 8 | 8 | 8 | 8 | 8 | 8 | 8 | 8 | 8 |
| | | merization | TPO | | | | | | | | | |
| | | initiator | | | | | | | | | | |
| | (e) | Surface | TEGO-Rad2100 | 0.1 | 0.1 | 0.1 | 0.1 | 0.1 | 0.1 | 0.1 | 0.1 | 0.1 |
| | | conditioner | | | | | | | | | | |
| | (f) | Storage | H-TEMPO | 0.3 | 0.3 | 0.3 | 0.3 | 0.3 | 0.3 | 0.3 | 0.3 | 0.3 |
| | | stabilizer | | | | | | | | | | |

| | | | | Examples | | | | | | | |
|---|---|---|---|---|---|---|---|---|---|---|---|
| Composition far support material | | | | S10 | S11 | S12 | S13 | S14 | S15 | S16 | S17 |
| Formulation | (a) | Water-soluble | HEAA | — | — | — | — | — | — | — | — |
| (parts by | | ethylenically | ACMO | 41.6 | 30 | 40 | 21 | 25 | 25 | 25 | 25 |
| weight) | | unsaturated | DMAA | — | — | — | — | — | — | — | — |
| | | monomer | | | | | | | | | |
| | (b) | Polyalkylene | PPG-400 | — | — | — | — | — | — | — | — |
| | | glycol | PPG-1000 | 45 | 26.6 | 20 | 49 | 45 | 33 | 46 | 35 |
| | | containing | PEG-400 | — | — | — | — | — | — | — | — |
| | | oxyethylene | PEG-1000 | — | — | — | — | — | — | — | — |
| | | group and/or | | | | | | | | | |
| | | oxypropylene | | | | | | | | | |
| | | group | | | | | | | | | |
| | (c) | Organic solvent | MTG | 5 | 35 | 31.6 | 21.6 | 24.6 | 21.6 | 26.6 | 14.6 |
| | | | DPMA | — | — | — | — | — | — | — | — |
| | (d) | Photopoly- | DAROCURE | 8 | 8 | 8 | 8 | 5 | 20 | 3 | 25 |
| | | merization | TPO | | | | | | | | |
| | | initiator | | | | | | | | | |
| | (e) | Surface | TEGO-Rad2100 | 0.1 | 0.1 | 0.1 | 0.1 | 0.1 | 0.1 | 0.1 | 0.1 |
| | | conditioner | | | | | | | | | |
| | (f) | Storage | H-TEMPO | 0.3 | 0.3 | 0.3 | 0.3 | 0.3 | 0.3 | 0.3 | 0.3 |
| | | stabilizer | | | | | | | | | |

TABLE 3

| | | | | Comparative Examples | | | | | |
|---|---|---|---|---|---|---|---|---|---|
| Composition for support material | | | | s1 | s2 | s3 | s4 | s5 | s6 |
| Formulation | (a) | Water-soluble | HEAA | — | — | — | — | — | — |
| (parts by | | ethylenically | ACMO | 15* | 55* | 40 | 25 | 40 | 20 |
| weight) | | unsaturated monomer | DMAA | — | — | — | — | — | — |
| | (b) | Polyalkylene glycol | PPG-400 | — | — | — | — | — | — |
| | | containing | PPG-1000 | 45 | 25 | 51.6* | 26.6 | 15* | 55* |
| | | oxyethylene group and/or | PEG-400 | — | — | — | — | — | — |
| | | oxypropylene group | PEG-1000 | — | — | — | — | — | — |
| | (c) | Organic solvent | MTG | 31.6 | 11.6 | — | 40* | 36.6* | 16.6 |
| | | | DPMA | — | — | — | — | — | — |
| | (d) | Photopolymerization initiator | DAROCURE TPO | 8 | 8 | 8 | 8 | 8 | 8 |
| | (e) | Surface conditioner | TEGO-Rad2100 | 0.1 | 0.1 | 0.1 | 0.1 | 0.1 | 0.1 |
| | (f) | Storage stabilizer | H-TEMPO | 0.3 | 0.3 | 0.3 | 0.3 | 0.3 | 0.3 |

*means range out of that defined in claim 1.
HEAA: N-Hydroxyethyl acrylamide [HEAA (ethylenic double bond/one molecule: one), manufactured by KJ Chemicals Corporation]
ACMO: Acryloylmorpholine [ACMO (ethylenic double bond/one molecule: one), manufactured by KJ Chemicals Corporation]
DMAA: N,N′-Dimethylacrylamide [DMAA (ethylenic double bond/one molecule: one), manufactured by KJ Chemicals Corporation]
PPG-400: Polypropylene glycol [UNIOL D400 (molecular weight: 400), manufactured by NOF CORPORATION]
PPG-1000: Polypropylene glycol [UNIOL D1000 (molecular weight: 1000), manufactured by NOF CORPORATION]
PEG-400: Polyethylene glycol [PEG#400 (molecular weight: 400), manufactured by NOF CORPORATION]
PEG-1000: Polyethylene glycol [PEG#1000 (molecular weight: 1000), manufactured by NOF CORPORATION]
MTG: Triethylene glycol mono methyl ether [MTG, manufactured by NIPPON NYUKAZAI CO., LTD.]
DPMA: Dipropylene glycol monomethyl ether acetate [DOWANOL DPMA, manufactured by The Dow Chemical Company]
DAROCURE TPO: 2,4,6-Trimethylbenzoyl-diphenyl-phosphine oxide [DAROCURE TPO, manufactured by BASF SE]
TEGO-Rad2100: Silicone acrylate having a structure of polydimethyl siloxane [TEGO-Rad2100, manufactured by Evonik Degussa Japan Co., Ltd.]
H-TEMPO: 4-Hydroxy-2,2,6,6-tetramethylpiperidine-N-oxyl [HYDROXY-TEMPO, manufactured by Evonik Degussa Japan Co., Ltd.]

(Measurement of Viscosity)

The viscosity of each of the compositions for the support material was measured under the conditions at 25° C. and a cone rotation number of 5 rpm using an R100-type viscometer (manufactured by TOKI SANGYO CO., LTD.) and was evaluated according to the following criteria. The evaluation results are shown in Tables 4 and 5.

### o: Viscosity ≤70 mPa s

### x: Viscosity >70 mPa s

(Solubility in Water)

In an aluminum cup of 50 mm in diameter, 2.0 g of each composition for a support material was collected. Next, an ultraviolet LED (NCCU 001E, manufactured by NICHIA CORPORATION) was used as an irradiation unit, and ultraviolet rays were irradiated to cure each composition for a support material so that the total irradiation light amount was 500 mJ/cm² to obtain a support material. Thereafter, the support material was released from the aluminum cup. Subsequently, the support material was immersed in 500 ml of ion-exchanged water placed in a beaker. The support material was visually observed every 10 minutes, the time taken from the start of immersion to complete dissolution or disappearance of the original shape (hereinafter referred to as water dissolution time) was measured and the solubility was evaluated according to the following criteria. The evaluation results are shown in Tables 4 and 5.

o: Water dissolution time ≤1 hour
Δ: 1 Hour <water dissolution time <1.5 hours
x: Water dissolution time ≥1.5 hours

(Evaluation of Oily Effusion)

1.0 g of each composition for a support material was collected to aluminum foil of 100 mm×100 mm. Next, an ultraviolet LED (NCCU 001E, manufactured by NICHIA CORPORATION) was used as an irradiation unit, and ultraviolet rays were irradiated to cure each composition for a support material so that the total irradiation light amount was 500 mJ/cm² to obtain a support material. Meanwhile, at this time point, the support material was in a solid state. The support material was left to stand for 2 hours, and the presence or absence of oily effusion on the surface of the support material was visually observed and evaluated according to the following criteria. The evaluation results are shown in Tables 4 and 5.

o: No oily effusion was observed at all.
Δ: A slight oily effusion was observed.
x: Many oily effusions were observed.

(Evaluation of Self-Supportability)

The glass plate (trade name “GLASS PLATE”, manufactured by AS ONE Corporation, 200 mm×200 mm×thickness 5 mm) used for the evaluation is a square in plain view. Spacers of 1 mm in thickness were disposed on four sides of the upper surface of the glass plate to form a square region of 10 cm×10 cm. After casting each composition for a support material in the region, another glass plate that was the same as the above was stacked and loaded. Then, an ultraviolet LED (NCCU 001E, manufactured by NICHIA CORPORATION) was used as an irradiation unit, and ultraviolet rays were irradiated to cure each composition for a support material so that the total irradiation light amount was 500 mJ/cm² to obtain a support material. Thereafter, the support material was released from the glass plate, and cut into a shape of a length of 10 mm and a width of 10 mm with a cutter to obtain a test piece. Next, 10 pieces of the test pieces were stacked to obtain a test piece group having a height of 10 mm. The test piece group was placed in an oven set at 30° C. as it was in a state that a weight of 100 g was placed on the top, and left to stand for 1 hour. Thereafter, the shape of the test pieces was observed, and the self-supportability was evaluated according to the following criteria. The evaluation results are shown in Tables 4 and 5.

o: There was no change in the shape.
Δ: The shape slightly changed, and the weight was inclined.
x: The shape changed significantly.

TABLE 4

| | Examples | | | | | | | | | | | | | | | | |
|---|---|---|---|---|---|---|---|---|---|---|---|---|---|---|---|---|---|
| Composition for support material | S1 | S2 | S3 | S4 | S5 | S6 | S7 | S8 | S9 | S10 | S11 | S12 | S13 | S14 | S15 | S16 | S17 |
| Viscosity (mPa · s) | ∘ | ∘ | ∘ | ∘ | ∘ | ∘ | ∘ | ∘ | ∘ | ∘ | ∘ | ∘ | ∘ | ∘ | ∘ | ∘ | — |
| Solubility in water | ∘ | ∘ | ∘ | ∘ | ∘ | ∘ | ∘ | ∘ | Δ | ∘ | ∘ | Δ | ∘ | ∘ | ∘ | ∘ | — |
| Oily effusion | ∘ | ∘ | ∘ | ∘ | ∘ | ∘ | ∘ | ∘ | ∘ | ∘ | Δ | ∘ | Δ | ∘ | ∘ | ∘ | — |
| Self-supportability | ∘ | ∘ | ∘ | ∘ | ∘ | ∘ | ∘ | Δ | ∘ | ∘ | ∘ | ∘ | Δ | ∘ | ∘ | x | — |

TABLE 5

| | Comparative Examples | | | | | |
|---|---|---|---|---|---|---|
| Composition for support material | s1 | s2 | s3 | s4 | s5 | s6 |
| Viscosity (mPa · s) | ∘ | ∘ | x | ∘ | ∘ | x |
| Solubility in water | ∘ | x | ∘ | ∘ | x | ∘ |
| Oily effusion | ∘ | ∘ | Δ | x | x | x |
| Self-supportability | x | ∘ | ∘ | ∘ | ∘ | ∘ |

As can be seen from the results in Tables 4 and 5, the composition for the support material of each of Examples S1 to S16 satisfying all the requirements of the present invention had a viscosity suitable for discharge from an inkjet head. Further, the support material obtained by photocuring the composition for the support material of each of Examples S1 to S16 had high solubility in water, and suppressed oily effusion. Furthermore, the support material obtained by photocuring the composition for the support material of each of Examples S1 to S15 had sufficient self-supportability. Meanwhile, since the content of the photopolymerization initiator (d) was less than 5 parts by weight, the radical reaction was not promoted with regard to the composition for the support material of Example S16 even when the ultraviolet LED was irradiated, and the self-supportability of the obtained support material was insufficient. With regard to the composition for the support material of Example S16, when a mercury lamp or a metal halide lamp was used as the irradiation unit, the obtained support material has sufficient self-supportability even if the content of the photopolymerization initiator (d) is 3 parts by weight.

In addition, with regard to Examples S1 to S8, S10, S11, and S13 to S16 in which the content of the water-soluble monofunctional ethylenically unsaturated monomer (a) was 45 parts by weight or less and the content of the polyalkylene glycol (b) was 25 parts by weight or more, the support material obtained from the composition for the support material had higher solubility in water. With regard to the support material obtained from the composition for the support material of each of Examples S1 to S10, and S14 to S16 in which the content of the polyalkylene glycol (b) was 45 parts by weight or less and the content of the water-soluble organic solvent (c) was 30 parts by weight or less, oily effusion was more suppressed. The support material obtained from the composition for the support material of each of Examples S1 to S7, S9 to S12, $14, and 515 in which the content of the water-soluble monofunctional ethylenically unsaturated monomer (a) was 25 parts by weight or more had more sufficient self-supportability.

On the other hand, since the content of the water-soluble monofunctional ethylenically unsaturated monomer (a) in the composition for the support material of Comparative Example s1 was less than 20 parts by weight, the self-supportability of the support material was insufficient. Since the content of the water-soluble monofunctional ethylenically unsaturated monomer (a) in the composition for the support material of Comparative Example s2 exceeded 50 parts by weight, the solubility in water of the support material was low. With regard to the composition for the support material of Comparative Example s3, since the content of the polyalkylene glycol (b) exceeded 49 parts by weight, the viscosity was high, and oily effusion occurred in the support material. With regard to the composition for the support material of Comparative Example s4, since the content of the water-soluble organic solvent (c) exceeded 35 parts by weight, oily effusion occurred in the support material. With regard to the composition for the support material of Comparative Example s5, since the content of the polyalkylene glycol (b) was less than 20 parts by weight, the solubility in water of the support material was low. In addition, with regard to the composition for the support material of Comparative Example s5, since the content of the water-soluble organic solvent (c) exceeded 35 parts by weight, oily effusion occurred in the support material. With regard to the composition for the support material of Comparative Example s6, since the content of the polyalkylene glycol (b) exceeded 49 parts by weight, the viscosity was high, and oily effusion occurred in the support material.

<Optically Shaped Article>

(Evaluation of Dimensional Accuracy of Optically Shaped Article)

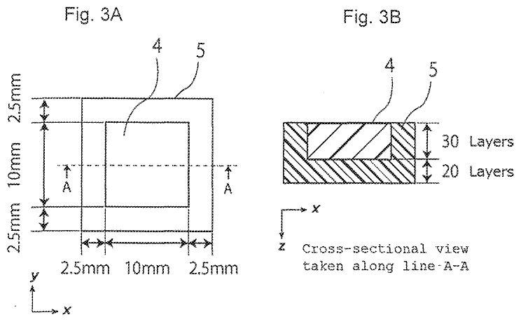

Using each composition for a model material and each composition for a support material of test Nos. 1 to 12 shown in Table 6, a cured product was made. The shape of the cured product and the target dimensions are shown in FIGS. 3 (a) and (b). Meanwhile, a step of discharging each composition for a model material and each composition for a support material from an inkjet head was performed so that the resolution became 600×600 dpi, and a thickness of one composition layer became about 13 to 14 μm. Additionally, a step of photocuring each composition for a model material and each composition for a support material, respectively, was performed using an LED light source of a wavelength 385 nm, which had been installed on a rear side of an inkjet head in a scanning direction, under the conditions of an illuminance of 250 mW/cm², and an integrated light quantity per one composition layer of 300 mJ/cm². Then, the support material was removed by immersing the cured product in ion-exchanged water to obtain an optically shaped article. Thereafter, the obtained optically shaped article was allowed to stand in a desiccator for 24 hours, and was sufficiently dried. By the above-described steps, each five of optically shaped articles of test Nos. 1 to 12 were produced. With regard to the optically shaped articles after drying, dimensions in an x direction and a y direction in FIG. 3(a) were measured using a slide caliper, and a change rate from the target dimension was calculated. For the dimensional accuracy, an average of a dimensional change rate in each of optically shaped articles of test Nos. 1 to 12 was obtained, and evaluation was performed using the average based on the following criteria. The evaluation results are shown in Table 6.

o: Average dimensional change rate is less than ±1.0%
x: Average dimensional change rate is ±1.0% or more

(Evaluation of Bleeding of Each Composition)

First, each 0.02 mL of each composition for a model material and each composition for a support material of test Nos. 1 to 12 shown in Table 6 were added dropwise on a film made of polyethylene terephthalate (A4300, manufactured by TOYOBO CO., LTD., 100 mm×150 mm×thickness 188 μm) using a micropipette. At this time, the composition for the model material and the composition for the support material were 10 mm in the distance of the center parts of each droplet, and each droplet was independent. Then, each droplet wettedly spread gradually, and after about 10 seconds, each droplet was bound. At this time, the state of an interface of respective droplets was observed visually from the upper direction, and bleeding was evaluated according to the following criteria. The results are shown in Table 6.

o: An interface between a layer made of a composition for a model material and a layer made of a composition for a support material became linear when viewed from the top, and no bleeding occurred.
x: At an interface between a layer made of a composition for a model material and a layer made of a composition for a support material, bleeding occurred.

TABLE 6

| | Composition | Composition | Dimensional accuracy | | |
|---|---|---|---|---|---|
| Test | for model | for support | x | y | Bleeding |
| No. | material | material | Direction | Direction | evaluation |
| 1 | M1 | S1 | ∘ | ∘ | ∘ |
| 2 | M2 | S2 | ∘ | ∘ | ∘ |
| 3 | M3 | S3 | ∘ | ∘ | ∘ |
| 4 | M4 | S4 | ∘ | ∘ | ∘ |
| 5 | M5 | S5 | ∘ | ∘ | ∘ |
| 6 | M6 | S6 | ∘ | ∘ | ∘ |
| 7 | M7 | S7 | ∘ | ∘ | ∘ |
| 8 | M8 | S10 | ∘ | ∘ | ∘ |
| 9 | M9 | S14 | ∘ | ∘ | ∘ |
| 10 | m1 | s5 | x | x | x |
| 11 | M1 | s5 | x | x | x |
| 12 | m1 | S1 | x | x | x |

As can be seen from the results in Table 6, with regard to the optically shaped articles of test Nos. 1 to 9 produced using the optical shaping ink set satisfying all the requirements of the present invention, bleeding did not occur at the interface of the layer made of the composition for the model material and the layer made of the composition for the support material, and the dimensional accuracy was good.

### INDUSTRIAL APPLICABILITY

The optical shaping ink set of the present invention can be suitably used for producing an optically shaped article with good dimensional accuracy using ink jet optical shaping method.

1. An optical shaping ink set used for inkjet optical shaping method, comprising in combination:
a composition for a model material used for shaping a model material; and
a composition for a support material used for shaping a support material,
wherein the composition for the model material contains, per 100 parts by weight of the total composition for the model material:
50 to 74 parts by weight of a monofunctional ethylenically unsaturated monomer (A);
26 to 50 parts by weight of a polyfunctional ethylenically unsaturated monomer (B); and
2 to 20 parts by weight of a photopolymerization initiator (C); and
wherein the composition for the support material contains, per 100 parts by weight of the total composition for the support material:
20 to 50 parts by weight of a water-soluble monofunctional ethylenically unsaturated monomer (a);
20 to 49 parts by weight of a polyalkylene glycol (b) containing an oxyethylene group and/or an oxypropylene group;
35 parts by weight or less of a water-soluble organic solvent (c); and
5 to 20 parts by weight of a photopolymerization initiator (d).

2. The optical shaping ink set according to claim 1, wherein in the composition for the model material, the polyfunctional ethylenically unsaturated monomer (B) contains an alkoxylated polyfunctional ethylenically unsaturated monomer, but does not contain an ethylenically unsaturated monomer having a urethane group.

3. The optical shaping ink set according to claim 1, wherein in the composition for the model material, the monofunctional ethylenically unsaturated monomer (A) contains a water-insoluble monofunctional ethylenically unsaturated monomer.

4. The optical shaping ink set according to claim 1, wherein in the composition for the model material, the photopolymerization initiator (C) is one or more selected from an acylphosphine oxide-based compound, an α-aminoalkylphenone-based compound, and an α-hydroxyketone-based compound.

5. The optical shaping ink set according to claim 1, wherein in the composition for the support material, the content of the water-soluble monofunctional ethylenically unsaturated monomer (a) is 25 to 45 parts by weight per 100 parts by weight of the total composition for the support material.

6. The optical shaping ink set according to claim 1, wherein in the composition for the support material, the content of the polyalkylene glycol (b) is 25 to 45 parts by weight per 100 parts by weight of the total composition for the support material.

7. The optical shaping ink set according to claim 1, wherein in the composition for the support material, the content of the water-soluble organic solvent (c) is 5 parts by weight or more per 100 parts by weight of the total composition for the support material.

8. The optical shaping ink set according to claim 1, wherein the composition for the support material further comprises 0.05 to 3.0 parts by weight of a storage stabilizer (e) per 100 parts by weight of the total composition for the support material.

9. An optically shaped article shaped by inkjet optical shaping method using the optical shaping ink set according to claim 1.

10. A method for producing an optically shaped article by inkjet optical shaping method using the optical shaping ink set according to claim 1, the method comprising:
step (I) of obtaining a model material by photocuring the composition for the model material and, and at the same time, obtaining a support material by photocuring the composition for the support material; and
step (II) of removing the support material.

11. The optical shaping ink set according to claim 2, wherein in the composition for the model material, the monofunctional ethylenically unsaturated monomer (A) contains a water-insoluble monofunctional ethylenically unsaturated monomer.
